(19) United States
(12) Patent Application Publication
(10) Pub. No.: US 2003/0028780 A1
(43) Pub. Date: Feb. 6, 2003

(54) Software controlled device

(76) Inventor: Alan Mark Burnett, Southampton (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/202,388

(22) Filed: Jul. 25, 2002

(30) Foreign Application Priority Data
Jul. 27, 2001 (GB) 0118311.0

(51) Int. Cl. H04L 9/00

(52) U.S. Cl. 713/180; 703/28

(57) ABSTRACT

A software controlled device comprises a central processing unit (CPU) and a memory unit. The CPU comprises a digital signature algorithm and a private key; wherein the memory unit stores run-time binary code. A digital signature is derived during manufacture from the digital signature algorithm, the private key and the run time binary code, then stored in the CPU and, in use, the CPU recalculates the digital signature and compares it with the stored digital signature, such that if the two signatures are not identical, the run-time code will not execute. A method of preventing fraudulent use of an electronic device comprising a central processing unit (CPU) and a memory unit is also provided. The method comprises passing run-time binary code and a private key through a digital signature algorithm during manufacture to derive a digital signature; storing the derived digital signature in the CPU; and in use, recalculating the digital signature and comparing it with the stored digital signature, such that if the two signatures are not identical, the run-time code will not execute.

This invention relates to a software controlled device, in particular for consumer electronic devices.

Many consumer electronic devices incorporate run-time software adapted to control the conditions of use of the device. For example, DVD players are set up to only operate in certain geographical regions, games consuls are adapted to only run games which have been purchased from the hardware manufacturer, or TV set-top boxes are designed to only permit the viewer access to those channels which have been paid for. A major problem for the producers of such hardware, is that hacked images of these products are made available e.g. via the internet, to allow users to overcome the manufacturer imposed restrictions. Another problem, in particular for mobile phone manufacturers, is that pirated software can invalidate expensive type approvals and make the equipment unreliable.

It is normal practice to include a binary image in FLASH/EPROM which causes the hardware to run. The manufacturer imposes restrictions via this binary image code. However, it is quite straightforward for a hacker to replace this code with pirate code in the FLASH/EPROM memory.

In accordance with a first aspect of the present invention a software controlled device comprises a central processing unit (CPU) and a memory unit; wherein the CPU comprises a digital signature algorithm and a private key; wherein the memory unit stores run-time binary code; wherein a digital signature is derived during manufacture from the digital signature algorithm, the private key and the run time binary code, then stored in the CPU; and wherein, in use, the CPU recalculates the digital signature and compares it with the stored digital signature, such that if the two signatures are not identical, the run-time code will not execute.

The present invention prevents hackers from overcoming the manufacturer imposed restrictions by simply reprogramming the memory unit. Instead they would have to replace the complete CPU, which is a more arduous and costly exercise. The private key may be generated internally by the CPU processor, but preferably the device further comprises a JTAG port (EEE 1149.1 (JTAG) boundary-scan standard) for programming the private key.

Preferably, the private key is at least a 128 bit key. Lesser keys could be used, but these would not provide the same level of security.

In accordance with a second aspect of the present invention, a method of preventing fraudulent use of an electronic device comprising a central processing unit (CPU) and a memory unit; the method comprising passing run-time binary code and a private key through a digital signature algorithm during manufacture to derive a digital signature; storing the derived digital signature in the CPU; and in use, recalculating the digital signature and comparing it with the stored digital signature, such that if the two signatures are not identical, the run-time code will not execute.

An example of a software controlled device according to the present invention will now be described with reference to the accompanying drawing in which:—

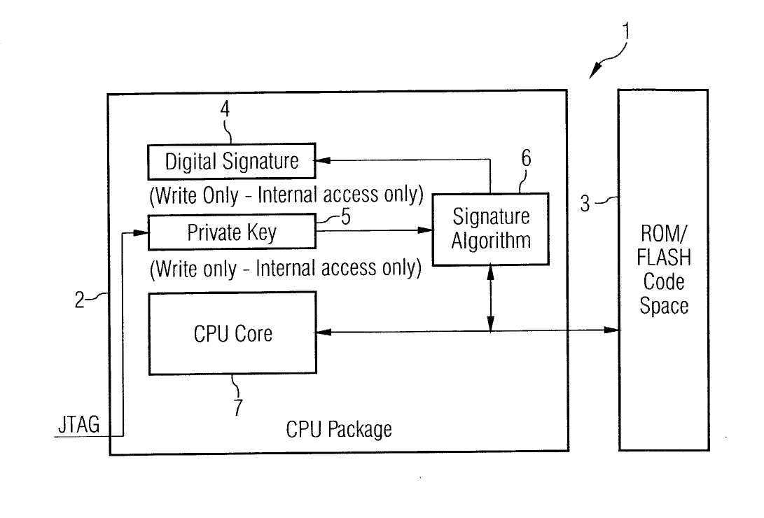

FIG. 1 is a block diagram of a device according to the invention.

An example of a software controlled device 1 comprises a CPU 2 and a programmable, read only memory, e.g. EPROM/FLASH etc., memory 3. The CPU includes a digital signature 4, a private key 5 and a signature algorithm 6, as well as a processor 7. A unique private key is written to the CPU and then used by the digital signature algorithm in conjunction with the run-time binary code stored in the memory 3 as the basis for deriving a digital signature for the device. There are various standard digital signature algorithms which could be used, for example RSA MD5. The digital signature 4 is stored in memory within the CPU and only internal access from the CPU is permitted. The digital signature is statistically very random, so difficult to guess without knowledge of the private key, although every time the run-time binary code and private key are used with the same algorithm, the same number will result allowing it to be used as a check. Neither the private key, nor the digital signature may be read back by a user. When a piece of software is run on the device, the CPU recalculates the signature using the run-time binary code in the memory 3 and then compares this with the digital signature 4 calculated at manufacture. If the signatures differ, the CPU enters a reset state and prevents the code from executing.

The private key may be generated internally by the processor 7, or else it can be programmed in via a JTAG port. If the private key is programmed via the JTAG port, it may be integrated into the manufacturing test process and a log of keys held by the manufacturer. In this case, the device may be unlocked by injecting the key via the JTAG port, for example if maintenance or upgrading is required. Although, this means that a user could attempt to determine the key by entering values through the JTAG port until one worked, it would be tedious, particularly, if the key was at least a 128 bit key, and it would only give access to that particular hardware device.

The device and method of the present invention are particularly suited to consumer electronics applications where “system on a chip” technology is used to integrate standard processors with peripherals on a single chip. Circumventing the protection by replacing the CPU will be difficult because generally the CPU's are specific to the manufacturer of the electronic device, and therefore not commercially available. Even where commercially available CPU's are used, the components are usually surface mounted and the rework needed tends to require relatively expensive industrial equipment, not generally available to the average hacker.

The device and method of the present invention have many applications. They can be used in mobile phones to prevent users from adding non-standard software for use in spare memory, which can invalidate type approval and interfere with safe operation of the network. The device may also be adapted to prevent the phone being cloned and operated by an unauthorised user. Although each phone has a unique hardware identifier, the network providers tend not to integrate information on stolen or cloned units, allowing a cloned phone to be used on any network, except for its original one, without difficulty. Companies supplying DVD player's can ensure that they are only used in the geographical area in which they are sold, because the disks that will operate on the player will have to be bought in the area where the equipment was bought, or else they will not work. Games on CD for use with game consuls will have to be legal copies. If they have been copied illegally, they will lack some of the tracks and with the present invention, the user cannot overcome this absence by using hacked run-time binary code instead. Typically, manufacturers make their money selling games, rather than from the consoles.

Another application is to prevent chipping of the electronic control unit (ECU) in vehicle engine management systems to allow increased engine performance, at the cost of reduce engine life. Operating system code can be installed on PC's at manufacture and locked to the particular hardware which the user has purchased, so that they cannot transfer it to another machine without the software provider's permission.

1. A software controlled device, the device comprising a central processing unit (CPU) and a memory unit; wherein the CPU comprises a digital signature algorithm and a private key; wherein the memory unit stores run-time binary code; wherein a digital signature is derived during manufacture from the digital signature algorithm, the private key and the run time binary code, then stored in the CPU; and wherein, in use, the CPU recalculates the digital signature and compares it with the stored digital signature, such that if the two signatures are not identical, the run-time code will not execute.

2. A device according to claim 1, further comprising a JTAG port for programming the private key.

3. A device according to claim 1 or claim 2, wherein the private key is at least a 128 bit key.

4. A method of preventing fraudulent use of an electronic device comprising a central processing unit (CPU) and a memory unit; the method comprising passing runtime binary code and a private key through a digital signature algorithm during manufacture to derive a digital signature; storing the derived digital signature in the CPU; and in use, recalculating the digital signature and comparing it with the stored digital signature, such that if the two signatures are not identical, the run-time code will not execute.

5. A method according to claim 4, wherein the private key is programmed via a JTAG port.
